(19) United States
(12) Patent Application Publication
(10) Pub. No.: US 2022/0282095 A1
(43) Pub. Date: Sep. 8, 2022

(54) Stimuli Responsive Dispersants For Architectural Coatings

(71) Applicant: WiSys Technology Foundation, Inc., Madison (US)

(72) Inventor: Elizabeth M. Glogowski, Eau Claire, WI (US)

(21) Appl. No.: 17/628,803

(22) PCT Filed: Jul. 22, 2020
(86) PCT No.: PCT/US20/43045

§ 371 Date: Jan. 20, 2022

Related U.S. Application Data
(60) Provisional application No. 62/877,090, filed on Jul. 22, 2019.

(51) Int. Cl. C09D 5/02; C09D 153/00; C08F 293/00

(52) U.S. Cl. CPC C09D 5/027; C09D 153/005; C09D 5/028; C08F 293/005; C08F 2438/01; C08F 2800/10

(57) ABSTRACT

A dispersing agent or dispersant formed as a block copolymer for use in surface coating compositions, such as architectural paint compositions, that can alter its properties as a result of changes in environmental conditions is provided. These stimuli-responsive copolymers are synthesized with properties that can be controlled based on number of blocks and block length and/or as a function of pH and temperature. The addition or these copolymers to coating compositions including other additives, such as pigments and/or fillers, can decrease settling rate, control viscosity, and control interfacial activity of the additives in the compositions.

### CROSS-REFERENCE TO RELATED APPLICATIONS

This application claims priority from U.S. Provisional Patent Application Ser. No. 62/877,090, filed on Jul. 22, 2019, the entirety of which is expressly incorporated herein by reference for all purposes.

### FIELD OF THE INVENTION

The present invention relates generally to dispersants, and more specifically to dispersants formed as copolymers utilized in paints and other architectural. coatings.

### BACKGROUND OF THE INVENTION

With regard to architectural structures, such as residential, commercial and other buildings, there is a need to provide the desired functional and/or aesthetic appearance to the interior and exterior surfaces of the building structures.

One manner in which the surfaces are altered to provide the desired appearance is to place a coating on the interior and/or exterior surface. There are a wide variety of coatings suitable for application to these surfaces, and in particular to interior and/or exterior wall surfaces. One widely utilized coating material for these surfaces is paint. Paint can provide the desired appearance due to the ability to produce the paint coating with many different colors and finishes to suit the surfaces on which the paint coating is to be applied.

Applications ranging from catalyst supports to abrasives and fillers require dispersing particulates and controlling the properties of the dispersion, such as architectural coatings, which are used for interior and exterior house paint, stains, and primers. The current market was valued at $26.39 billion in North America and Europe in 2016 with expected continued growth through 2023. New technologies are being developed globally for architectural coatings as consumers are more aware of the drawbacks of traditional solvent-borne systems with high volatile organic compound (VOC) content. The demand for water-borne coatings of higher quality and with more customized features is increasing in North America and the European Union due to both consumer expectations and environmental regulations.

A drawback with regard to the use of paint coatings is the need to prime the surfaces on which the paint is to be applied prior to the application of the paint. The priming step is often required in order to provide a base on the surface to which the paint can sufficiently adhere, and also that enables the paint to more readily cover or obscure the color of the underlying surface. The use of a primer can reduce the number of coats of the paint coating that are required to achieve the desired appearance for the surface, but the primer application itself results in a significant amount of additional time and expense for the placement of the desired coating on the surface.

Recently, paint coatings have been developed that include primer components within the paint coating, in order to enable the priming and coating steps to be performed simultaneously. This results in a significant time and cost savings for the application of the paint coating to the selected surface(s).

These all-in-one primer and paint coatings are formulated to include additives, such as titanium dioxide, that increase the opacity of the coating material in order to provide the primer functionality to the all-in-one paint coating. The volume of the titanium dioxide required to provide this attribute often exceeds the amount which can remain in suspension within the coating. As a result, the titanium dioxide settles out of the coating, requiring the coating to be initially formed with an excess amount of the titanium dioxide in the coating composition, resulting in a significant waste of the additives from the manufacture of the all-in-one coating compositions.

In addition, while rutile titanium dioxide particulates are used in architectural coatings for their ability to scatter light to make the coating opaque, the production of titanium dioxide is expensive and environmentally costly. A shortage of titanium dioxide affected the prices of architectural coatings between 2010 and 2012. Typically, the titanium dioxide dispersion is worse than random, meaning a larger amount of titanium dioxide is needed to achieve the desired product performance. Improving the dispersion of the titanium dioxide would decrease the cost, environmental impact, and effect of supply volatility on the architectural coating supply chain. Improving the dispersion would also improve the opacity of the coating, which would improve the performance of paint and-primer-in-one coatings as well as one-coat-hide coatings. These are predicted to increase in demand in North America through 2023 due to installation time savings and labor savings for contractors and home consumers.₁ Improving the quality of the titanium dioxide dispersion would reduce the amount of VOCs and other additives needed to achieve the desired performance and meet consumer demand for higher quality coatings with improved coverage.

To increase the ability of these coating compositions to retain the titanium dioxide particles and other additives in suspension longer, various dispersants have been added to the coating compositions. A recent example of improving titanium dioxide dispersions for architectural coating applications is the Evoque Pre-composite Polymer system from Dow Chemical. This technology improves the particulate dispersion of titanium dioxide for water-borne coatings, and has been incorporated into a wide range of architectural coating applications at different price points under different coating brands.

However, these dispersants, while capable of retaining the additives, such as titanium dioxide, in suspension longer, often detrimentally affect the viscosity of the paint coating composition in general, e.g., causing the paint coating composition to have an overly low viscosity (to thin or runny) or an overly high viscosity (too thick or paste-like).

A major cause of these issues with regard to the dispersants is the environmental conditions in which the coating composition is applied to the surface, such that a coating composition with a dispersant type and/or amount that is effective under certain environmental conditions is rendered unusable when applied under different environmental conditions.

As a result, it is desirable to develop dispersants that can accommodate for the changes in environmental conditions to enable coating compositions including the dispersants to be uniformly applied even under different environmental conditions.

### SUMMARY OF THE INVENTION

Briefly described, according to an exemplary embodiment of the invention is a dispersing agent or dispersant for use in surface coating compositions, such as architectural and/or paint compositions, that can alter its properties as a result of changes in environmental conditions. New stimuli-responsive copolymers have been synthesized with properties that can be controlled based on the number of blocks and block length and/or as a function of pH and temperature. The addition of these copolymers to coating compositions including other additives, such as pigments and/or fillers, can decrease settling rate, control viscosity, and control interfacial activity of the additives in the compositions.

These stimuli-responsive polymeric materials have the potential to improve current architectural coating applications. Stimuli-responsive polymers undergo a dramatic switch in properties, such as viscosity and interfacial activity, in response to a small change in an external stimulus such as temperature and pH. Adding stimuli responsive polymers to current polymer dispersant technologies for architectural coatings has the potential to improve features of current technologies and improve the shelf-life of current architectural coatings across the market, specifically for interior and exterior paint applications. Properties of stimuli-responsive polymer dispersants are reversible with a change in temperature or pH. Achieving the right balance of properties of polymer dispersants for architectural coatings is challenging, particularly for long-term shelf stability and stability once applied to the desired surface or wearability. Incorporating stimuli-responsive materials has the potential to overcome these current limitations by building in switchable properties to reverse undesirable aggregation on the shelf and control of the dispersion and behavior once the coating is applied.

The dispersant is formed from a stimuli-responsive polymer that has the ability to change the cloud point of the polymer based on alterations in environmental conditions. The changes in the cloud point enable the polymer to alter the temperature threshold at which the polymer changes from being soluble (hydrophilic) to insoluble (hydrophobic). This consequently enables the polymer to alter the solubility, viscosity, interfacial activity and other properties of the coating composition in which the polymer is present as a result of the changing environmental conditions. This property of the copolymer dispersant can be utilized to tune the properties of the dispersion as desired, including the ability to alter the properties of art existing product including the copolymer dispersant to tailor the product for a desired use or environment or to re-adjust the properties of an aged existing product to those similar or identical to a newly produced product, essentially regenerating older products for current use.

According to another exemplary embodiment of the invention, the stimuli-responsive polymer is formed as a block copolymer, such as a diblock copolymer or a triblock. copolymer, formed of polyethylene glycol and poly(2-dimethylaminoethyl methacrylate) polymers connected in a linear and uninterrupted fashion. The polymer blocks utilized in the formation of the block copolymer provide different functions for the stimuli-responsive polymer when interacting with the additives in a coating composition.

According to still another exemplary embodiment of the invention, the addition of the stimuli-responsive polymer to coating compositions increases the dispersion of the additives within the coating composition under varying environmental conditions. This consequently enables the additives to be utilized in reduced amounts within the coating composition while achieving the same or better results from the additives present in the coating composition due to the increased dispersion of the additives, thereby reducing production costs for the coating compositions.

Numerous other aspects, features, and advantages of the invention will be made apparent from the following detailed description.

### BRIEF DESCRIPTION OF THE DRAWING FIGURES

The drawing figures illustrate the best mode currently contemplated of practicing the present invention.

In the drawings:

FIG. 1 is a scheme for the synthesis of a block copolymer according to one exemplary embodiment of the invention.

FIGS. 2-2A are schemes for the synthesis of a block copolymer according to another exemplary embodiment of the invention.

FIG. 3 is a graph of the nuclear magnetic resonance spectrum of the synthesized polymer of FIG. 2.

FIG. 4 is a schematic illustration of the change in solution properties upon reaching cloud point of a block copolymer in solution.

FIG. 5 is a graph of transmittance versus temperature for different block copolymers.

FIG. 6 is a graph of cloud point versus pH for different block copolymers.

FIG. 7 is a graph. of transmittance versus temperature for PEG₁₂₇-b-PDMAEMA₁₄₀ block copolymer at different pH values.

FIG. 8 is a graph of transmittance versus temperature for PEG₁₂₇-b-PDMAEMA₂₇₈ block copolymer at different pH values.

FIG. 9 is a graph of particle size versus temperature for different low MW and high MW diblock copolymers.

FIGS. 10-10A are schematic illustrations of the dispersion properties of a diblock copolymer on surface-coated titanium oxide in solution.

FIG. 11 is a graph of cloud point versus molecular weight for diblock copolymers at different pH values.

FIG. 12 is a graph of transmittance versus temperature for diblock copolymers at pH 8.

FIG. 13 is a graph of transmittance versus temperature for diblock copolymers at pH values of 10 and 12.

FIG. 14 is a graph of cloud point versus copolymer concentration for diblock copolymers at pH values of 8, 10 and 12.

FIG. 15 is a graph of interfacial tension versus temperature of diblock and triblock copolymers (pH 12 0.01M, 1 mg/mL).

FIG. 16 is a graph of interfacial tension versus temperature of diblock and triblock copolymers (pH 8 and pH 12 0.01M, 1 mg/mL).

FIG. 17 is a graph of interfacial tension versus time for diblock copolymer at different temperatures (PEG₁₂₇-b-PDMAEMA₁₄₀, or 5 k 1:1 diblock copolymer, 10 mg/mL, pH 8 0.1M).

FIG. 18 is a graph of interfacial tension versus polymer concentration for diblock copolymer at different temperatures (PEG₁₂₇-b-PDMAEMA₂₇₈ or 5 k 1:2 diblock copolymer, pH 8 0.1M).

FIG. 19 is a graph of interfacial tension versus buffer concentration at different pH values and copolymer concentrations for PEG₁₂₇-b-PDMAEMA₁₄₀ diblock copolymer.

FIG. 20 is a graph of the average viscosity of PDMAEMA₁₁₆-b-PEG₁₃₆-b-PDMAEMA₁₁₆ or 6K 1:1:1 triblock copolymer, pH 8, 1 mg/mL at varying temperatures.

FIG. 21 is a graph of the average viscosity of PDMAEMA₁₁₆-b-PEG₁₃₆-b-PDMAEMA₁₁₆ or 6K 1:1:1 triblock copolymer, pH 8, 10 mg/mL at varying temperatures.

FIG. 22 is a graph of the average viscosity of PDMAEMA₁₁₆-b-PEG₁₃₆-b-PDMAEMA₁₁₆ or 6K 1:1:1 triblock copolymer, pH 12, 1 mg/mL at varying temperatures.

FIG. 23 is a graph of the average viscosity of PDMAEMA₁₁₆-b-PEG₁₃₆-b-PDMAEMA₁₁₆ or 6K 1:1:1 triblock copolymer, pH 12, 10 mg/mL at varying temperatures.

FIG. 24 is a graph of the average viscosity of PEG₁₂₇-b-PDMAEMA₁₄₀ or 5 k 1:1 diblock copolymer, 20° C. at varying pH values and copolymer concentrations.

FIG. 25 is a graph of viscosity versus shear rate for PEG₁₂₇-b-PDMAEMA₁₄₀ diblock and PDMAEMA₁₁₆-b-PEG₁₃₆-b-PDMAEMA₁₁₆ triblock copolymers at pH 7 0.1M and 10 mg/mL with and without TiO₂ particles.

FIG. 26 is a graph of settling versus time for TiO₂ particles alone, with PEG and with diblock and triblock copolymers.

FIG. 27 is a graph of % intensity versus particle sire for TiO₂ particles in solution at 20° C. at 1 day and 7 days.

FIG. 28 is a graph of % intensity versus particle size for TiO₂ particles and PDMAEMA₁₁₆-b-PEG₁₃₆-b-PDMAEMA₁₁₆ triblock copolymer in solution at 20° C. at 1 day and 7 days.

FIG. 29 is a graph of intensity versus particle size of silicon oxide coated TiO₂ particles in buffer (pH 7, 0.1M) at varying temperatures.

FIG. 30 is a graph of intensity versus particle size of silicon oxide coated TiO₂ particles and PEG₄₅-b-PDMAEMA₈₄ diblock copolymer (10 mg/mL) in buffer (pH 7, 0.1M) at varying temperatures.

FIG. 31 is a graph of intensity versus particle size of silicon oxide coated TiO₂ particles in buffer (pH 8, 0.1M) at varying temperatures.

FIG. 32 is a graph of intensity versus particle size of silicon oxide coated TiO₂ particles and PEG₄₅-b-PDMAEMA₈₄ diblock copolymer (10 mg/mL) in buffer (pH 8, 0.1M) at varying temperatures.

FIG. 33 is a graph of viscosity versus polymer concentration for silicon oxide coated TiO₂ particles, various triblock and diblock copolymers and the triblock and diblock copolymers with the silicon oxide coated TiO₂ particles in solution at pH 8 0.1M.

FIG. 34 is a graph of viscosity versus shear rate for commercial paint products and combination/ratios of rheology modifier with PDMAEMA₉₄-b-PEG₄₅-b-PDMAEMA₉₄ triblock copolymer/Ti Select TiO₂ particles at 15° C.

FIG. 35 is a graph of viscosity versus shear rate for commercial paint products and combination/ratios of rheology modifier with PDMAEMA₉₄-b-PEG₄₅-b-PDMAEMA₉₄ triblock copolymer/Ti Select TiO₂ particles and PEG₄₄-b-PDMAEMA₅₇ diblock copolymer/Ti Select TiO₂ particles at 15° C.

### DETAILED DESCRIPTION OF THE INVENTION

Reference will now be made in detail to various embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

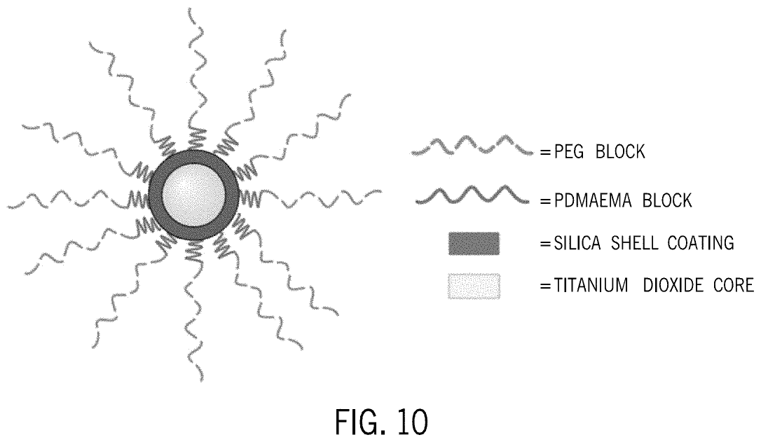

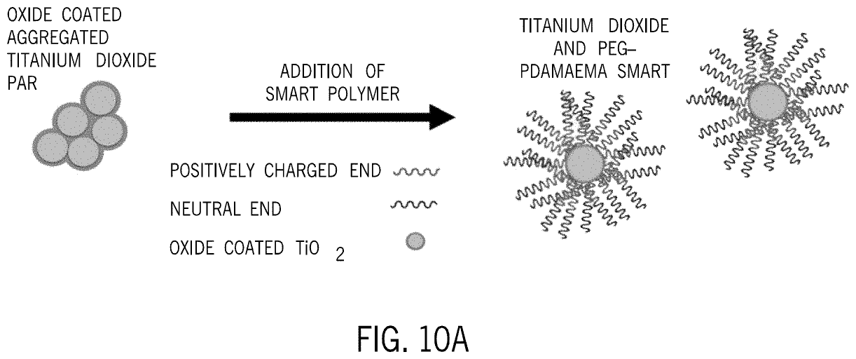

Improving polymer dispersant technologies requires tuning the properties of the polymer for the application. Titanium dioxide is known to damage organic materials, including polymer dispersants. Therefore, the titanium dioxide particulates for architectural coating applications are frequently coated with silica or zirconia to prevent damage to the surrounding organic material. The polymer dispersant therefore must be designed to work with the silica or zirconia coating. Both silica and zirconia have a negative surface charge when in water at neutral or basic pH. Therefore, a polymer dispersant with a positive charge will interact favorably with either silica or zirconia. Polyethylene glycol-block-poly((2-dimethylamino)ethyl methacrylate) or PEG-PDMAEMA is a stimuli-responsive polymer that switches properties with changes in temperature and pH. The PDMAEMA block has a positive charge in neutral water and is predicted to associate or adsorb to the silica or zirconia surface. The adsorption of the stimuli-responsive copolymer improves the dispersion of the silica- or zirconia-coated titanium dioxide particulates. FIGS. 10-10A illustrates the adsorption of PEG-PDMAEMA copolymers to silica-coated titanium dioxide.

The composition of the copolymer directly affects the polymer properties in water and determines the efficacy of these materials as stimuli-responsive polymer dispersants. The use of a stimuli-responsive polymer as a polymer dispersant will build in control of the properties of the dispersion with changes to temperature and pH. As the dispersion fails over time, a small change in temperature or pH has the potential to enable switchable control over the properties, to either reuse or recycle the material. The control over mechanical properties enhances the stability of the material once applied by tuning the mechanical properties as a function of temperature and pH. To determine whether PEG-PDMAEMA is a candidate for architectural coating applications, the material must be synthesized, characterized, and tested as a polymer dispersant.

Therefore, the synthesis, characterization, and testing of PEG-PDMAEMA copolymers for polymer dispersant applications for architectural coatings have been performed. With regard to the synthesis of the copolymers, while PEG-PDMAEMA has been successfully synthesized using atom transfer radical polymerization (ATRP), new methods have been. developed recently to decrease cost and environmental impact of the polymer preparation. This synthetic method, activator regenerated by electron transfer atom transfer radical polymerization or ARGET ATRP, is currently in use for the production of PEG-PDMAEMA copolymers. Current researchers have successfully prepared PDMAEMA homopolymers using this approach, but the AGRET ATRP approach has been extended here to production of the proposed copolymers.

In addition to previously characterized PEG-PDMAEMA diblock copolymers, new PDMAEMA-PEG-PDMAEMA triblock copolymers have been prepared to understand how changing the structure will change the properties. All the prepared diblock and triblock copolymers have been evaluated and characterized to understand their stimuli responsive behavior and to understand how changing the composition will affect the material's use as a polymer dispersant. Initial testing has been performed on the diblock copolymers and the triblock copolymers to be characterized as a function of polymer composition, pH, and temperature. The best candidates, with stimuli-responsive behavior within the needed temperature and pH ranges, have additionally been tested as polymer dispersants with silica-coated titanium dioxide of the type(s) commonly used in architectural coating applications.

For initially forming the copolymers to be evaluated, the polymers synthesized were the diblock copolymer:

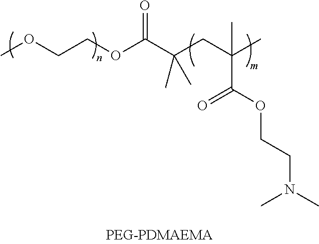

wherein n is between 44 and. 127, and wherein m is between 44 and 278 or the triblock copolymer:

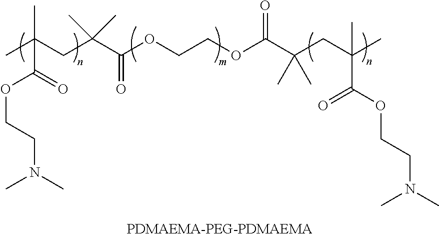

wherein n is between 45 and 136, and wherein m is between 49 and 135.

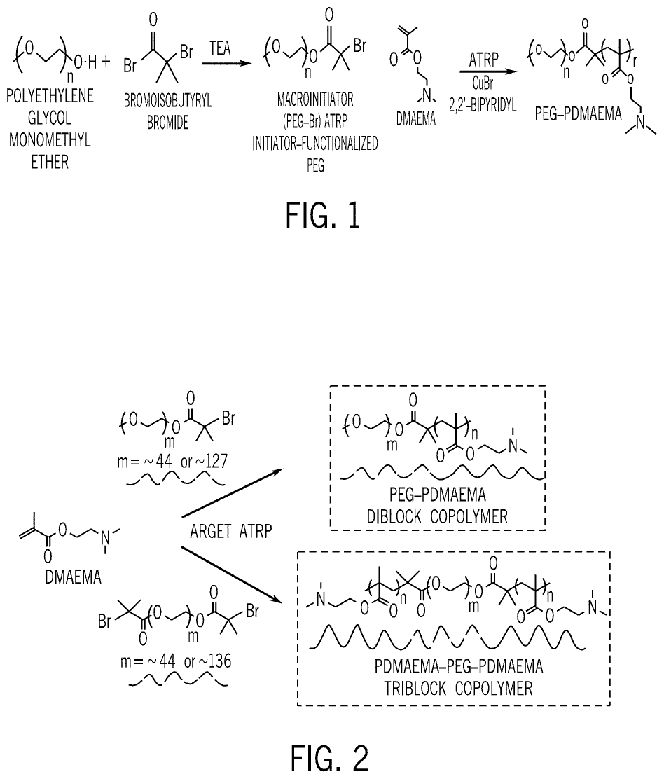

The synthesis scheme illustrated in FIG. 1 utilizing Atom Transfer Radical Polymerization (ATRP) was used to synthesize PDMAEMA diblock copolymers. Macroinitiator was synthesized using PEG and BIBB. DMAEMA (5 mL, 30 mmol) was mixed with methanol (3 mL) in a flask, and macroinitiator (amount dependent on target molar ratio, between 0.5 g and 5.2 g) was dissolved in methanol (2 mL) in a separate flask. Both flasks were subjected to five freeze-pump-thaw cycles, and CuBr catalyst (0.0426 g, 0.30 mmol) and bipyridyl ligand (0.0928 g, 0.60 mmol) were added on the last freeze cycle. Both flasks were purged with nitrogen and thawed before the macroinitiator solution was added to the DMAEMA solution. The reaction mixture was stirred at 20° C. for 6 to 48 hours. The polymerization was terminated by quenching with methanol. Polymer was isolated by filtering over neutral alumina, concentrated in vacuo and precipitated into hexanes. The polymer was dried in a vacuum oven at 75° C. to yield the white solid polymer. In the process, molecular weight was controlled through changing the ratio of initiator to monomer. Using ATRP resulted in the synthesis of diblock copolymers with controlled molecular weight and narrow molecular weight ranges, as illustrated in Table 1:

TABLE 1
Molecular Weights of PDMAEMA Diblock
Copolymers Synthesized by ATRP

| Resulting block | | Mn | Molar Ratio | |
|---|---|---|---|---|
| copolymers | Mn PEG | PDMAEMA | PEG:PDMAEMA | Ðₘ |
| PEG₄₅-b- | 2,000 | 6,900 | 1:1.10 | 1.13 |
| PDMAEMA₄₄ | | | | |
| PEG₄₅-b- | 2,000 | 13,000 | 1:1.87 | 1.09 |
| PDMAEMA₈₄ | | | | |
| PEG₄₅-b- | 2,000 | 17,000 | 1:2.50 | 1.15 |
| PDMAEMA₁₁₀ | | | | |
| PEG₁₂₇-b- | 5,600 | 22,000 | 1:1.12 | 1.26 |
| PDMAEMA₁₄₀ | | | | |
| PEG₁₂₇-b- | 5,600 | 44,000 | 1:2.30 | 1.32 |
| PDMAEMA₂₇₈ | | | | |

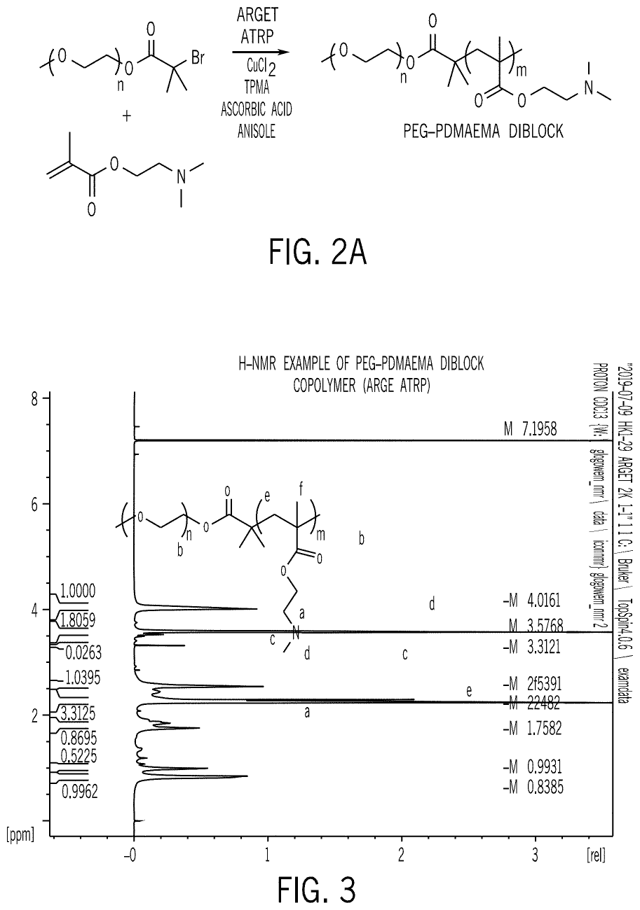

In an alternative synthesis method, as shown in the scheme(s) of FIGS. 2 and 2A, the method utilized is an Activator Regenerated by Electron Transfer Atom Transfer Radical Polymerization (ARGET ATRP) for the synthesis of the diblock and triblock PEG-PDMAEMA copolymers. ARGET ATRP reduces the amount of copper catalyst needed for controlled polymerization. This decreases the cost of the polymerization and the environmental impact, both through the use of less copper, and the use of fewer reagents for the purification of the final material. In this scheme, PEG-PDMAEMA stimuli-responsive polymers are created through the use of a prepared Macroinitiator (PEG-Br) which is then synthesized to create block copolymers. The method of ARGET ATRP when used requires less set-up time than the ATRP method. In addition, by changing the macroinitiator ratio in comparison to each. monomer, molecular weight can be controlled, and by controlling molecular weight, ATRP produces block copolymers that are set variances of PEG-PDMAEMA. Manipulating PEG-PDMAEMA block copolymers in different styles offers different characteristics for the block copolymers.

In particular, in the scheme of FIGS. 2 and 2A, the macroinitiator was synthesized using PEG and BIBB. ^{1, 2}PDMAEMA-PEG-PDMAEMA and PEG-PDMAEMA were synthesized using ARGET ATRP in which the synthesis proceeded as follows. The inhibitor was removed from DMAEMA by passing it through basic alumina by gravity over a coarse fritted filter. DMAEMA (5 mL) along with anisole (5 mL) were added to a round bottom flask. ³Macroinitiator amount was weighed and placed in a small round bottom flask along with anisole (3 mL-5 mL). Ascorbic acid, CuCl₂, and TPMA were added to the DMAEMA [10:1:5:2500] and anisole mixture, stirred with a stir bar, and placed in an oil bath at 50° C. ^{3, 4, 5}Contents in macroinitiator flask were then added to the flask containing DMAEMA. Mixture was left stirring under nitrogen for 24 hours to 48 hours at 50° C. Synthesis was terminated by oxygen. Polymer was isolated by precipitating anisole in hexane, filtering through neutral alumina with methanol, filtering through silica with acetonitrile and precipitating polymer remains in hexane. Polymer was left in a vacuum oven for 24 hours to remove any remaining residuals. Confirmation of the structure of the diblock copolymers was confirmed by proton nuclear magnetic resonance (NMR) spectroscopy, one example of which is illustrated in FIG. 3 with regard to diblock copolymer PEG₄₄-b-PDMAEMA₅₇. Using ARGET-ATRP resulted in the synthesis of diblock and triblock copolymers with controlled molecular weight and narrow molecular weight ranges, as illustrated in Table 2:

TABLE 2
Molecular Weights of PDMAEMA Diblock and Triblock
Copolymers Synthesized by ARGET-ATRP

| | | | Molar Ratio | |
|---|---|---|---|---|
| Resulting block | Mn | Mn | (PDMAEMA): | |
| copolymers | PEG | PDMAEMA | PEG:PDMAEMA | Ðₘ |
| PEG₄₄-b- | 2,000 | 7,000 | 1:1.04 | 1.14 |
| PDMAEMA₄₆ | | | | |
| PEG₄₄-b- | 2,000 | 9,000 | 1:1.29 | 1.47 |
| PDMAEMA₅₇ | | | | |
| PEG₄₄-b- | 2,000 | 31,000 | 1:4.49 | 1.35 |
| PDMAEMA₁₉₈ | | | | |
| moePEG₅₈-b- | 2,600 | 8,000 | 1:0.88 | 1.17 |
| PDMAEMA₅₁ | | | | |
| PDMAEMA₄₉-b- | 2,000 | 8,000 each | 1.08:1:1.08 | 1.36 |
| PEG₄₅-b- | | block | | |
| PDMAEMA₄₉ | | | | |
| PDMAEMA₉₄-b- | 2,000 | 15,000 each | 2.08:1:2.08 | 1.39 |
| PEG₄₅-b- | | block | | |
| PDMAEMA₉₄ | | | | |
| PDMAEMA₁₃₅-b- | 2,000 | 21,000 each | 3.01:1:3.01 | 1.35 |
| PEG₄₅-b- | | block | | |
| PDMAEMA₁₃₅ | | | | |
| PDMAEMA₁₁₆-b- | 6,000 | 18,000 each | 0.85:1:0.85 | 1.43 |
| PEG₁₃₆-b- | | block | | |
| PDMAEMA₁₁₆ | | | | |

### Experimental

With the synthesized diblock and triblock copolymers, the stimuli-responsive properties of the target polymers described has been determined as a function of polymer composition, pH, temperature, and polymer concentration. The stimuli-responsive properties for PEG-PDMAEMA copolymers prepared by ARGET ATRP are highly similar if not identical to those prepared by ATRP.

Polymer solubility, viscosity, and interfacial. activity depend on temperature and pH for PDMAEMA copolymers. PDMAEMA copolymers are water soluble at low pH and low temperature, and become insoluble in basic solutions above the cloud point temperature. Determining the temperature when solubility switches as a function of pH, polymer composition, and polymer concentration is necessary for using these materials as polymer dispersants for architectural coatings. The coating formulation will have a fixed pH and working temperature range. Understanding how polymer composition and concentration affect polymer solubility, viscosity, and interfacial activity is necessary in order to select the best candidate for polymer dispersions. Both solubility and interfacial activity affect how the PDMAEMA copolymer acts as a polymer dispersant with oil and water between 15° C. and 75° C.

Viscosity is an important property for dispersions of polymers and particulates, Understanding how viscosity changes with changing polymer composition, polymer concentration, pH, and temperature enables focusing on appropriate PDMAEMA copolymers for further testing in architectural coating compositions. The viscosity of PDMAEMA copolymer solutions has been determined to directly depend on polymer composition and/or concentration, and additional testing has provided insight regarding how triblock vs. diblock composition affects viscosity of the polymers in aqueous solution.

The testing performed in this experimental section has determined how temperature, pH, and polymer concentration affect the interfacial activity, viscosity, and solubility of the synthesized diblock and triblock PDMAEMA copolymers. This information has been used to test the best candidate as a polymer dispersant with controlled solubility, viscosity, and interfacial activity at neutral and slightly basic pH, and temperature ranges between 1° C. and 75° C.

### Cloud Point/Solubility

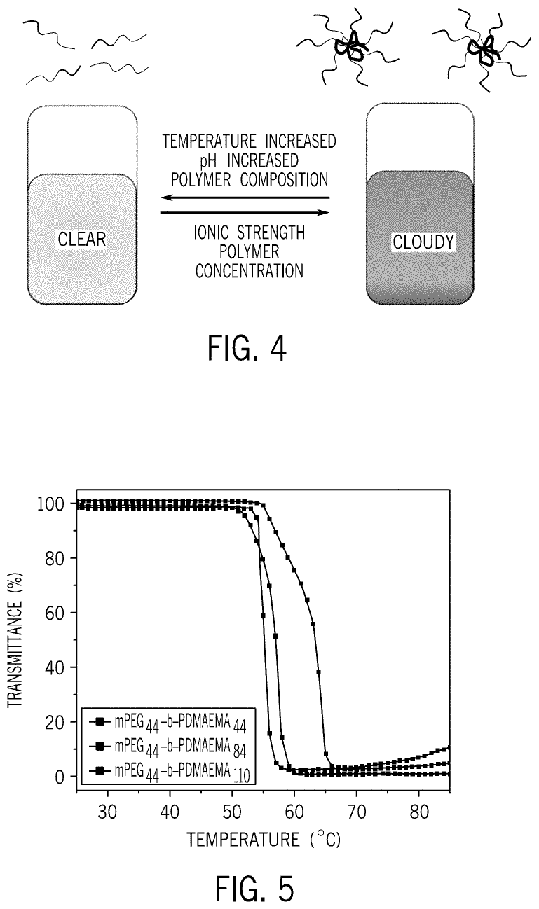

The synthesized copolymers were initially evaluated to determine the effects of temperature on the cloud point, or the temperature at which the copolymer changes properties from being soluble (hydrophilic) to insoluble (hydrophobic) in water. Cloud point affects solubility, viscosity, interfacial activity, and other properties of the solution. This property is schematically illustrated in FIG. 4 where increased temperature and/or increased pH causes the copolymer to come out of solution and causes the carrier to become cloudy as a result of the insoluble copolymer present. In evaluating this property, the solubility of a number of block copolymers was tested at various temperatures (FIG. 5) using UV-Vis spectroscopy to determine the effect of varying temperatures and pH levels on the solubility of the block copolymers. As shown in FIG. 5, solubility greatly decreased as a function of temperature for these block copolymers.

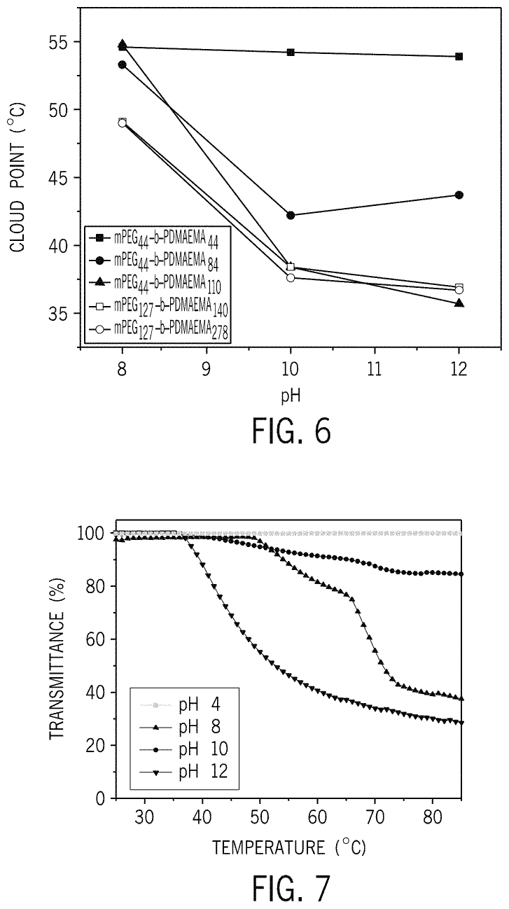

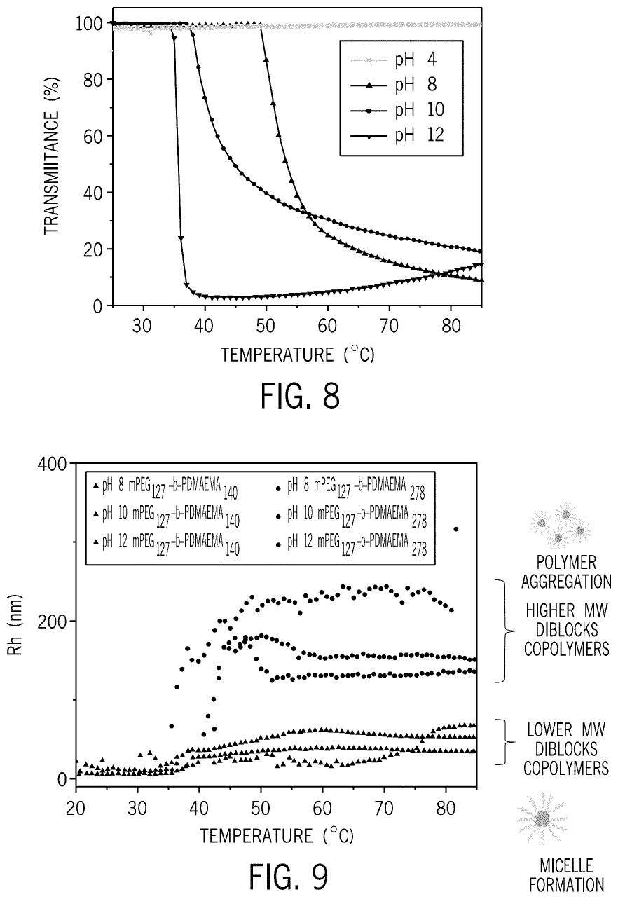

The block copolymers were then evaluated with regard to pH to determine the changes in cloud point as a result of changes in pH values. The results shown in FIG. 6 illustrate a significant change in cloud point between pH values of approximately 8-10, with a relatively flat response from pH 10 to pH 12. In addition, FIGS. 7 and 8 show the percentage of light transmittance through a solution including PEG₁₂₇-b-PDMAEMA₁₄₀ and PEG₁₂₇-b-PDMAEMA₂₇₈ respectively at different pH values as a function of changes in temperature. As illustrated, the transmittance is significantly reduced at pH values of 8-12 with increasing temperature, showing that micelle or aggregate formation of the block copolymer occurs at these elevated temperatures.

Further, in FIG. 9, using the dynamic light scattering (DLS) method the average size of the particles in solution as the temperature increases were evaluated for low molecular weight (MW) diblock copolymers and high MW diblock copolymers. The results of FIG. 9 illustrate that while micelles are formed by low MW diblock copolymers with increasing temperature, aggregates are formed at higher temperatures when high MW diblock copolymers are utilized. With the composition of the copolymers including a positively charged PDMAEMA end, which attach to the silicon oxide-coated titanium dioxide as a function of pH, and a neutral PEG end positioned outwardly from the titanium dioxide particle, micelle formation shown here illustrates that the copolymer will coat the individual titanium dioxide particles, maintaining the dispersion of the particles and physically preventing the copolymer coated particles from aggregating, as shown in FIG. 10.

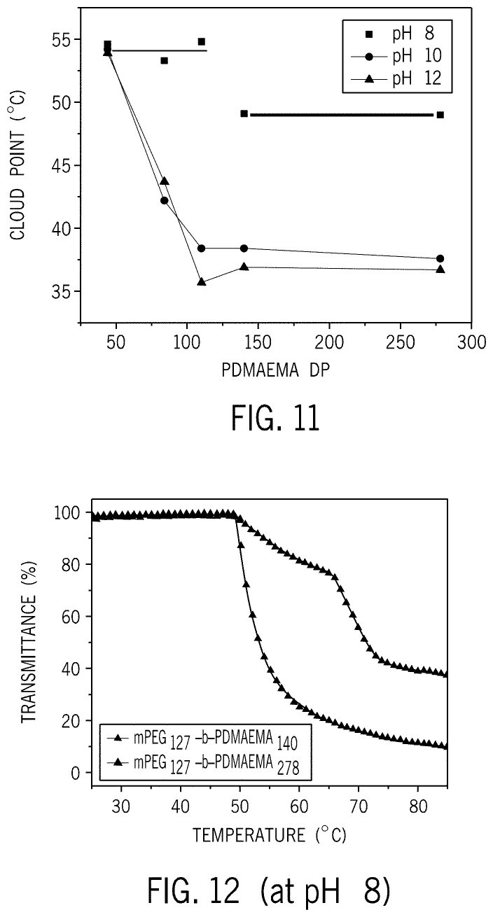

The block copolymers were also evaluated to compare cloud point with block copolymer composition. As shown in FIG. 11, the cloud point at pH levels of 10 and 12 drops significantly with increasing MW of the diblock copolymer until reaching a plateau between a MW of 100 to 150, while MW variation at pH 8 has no effect on the cloud point.

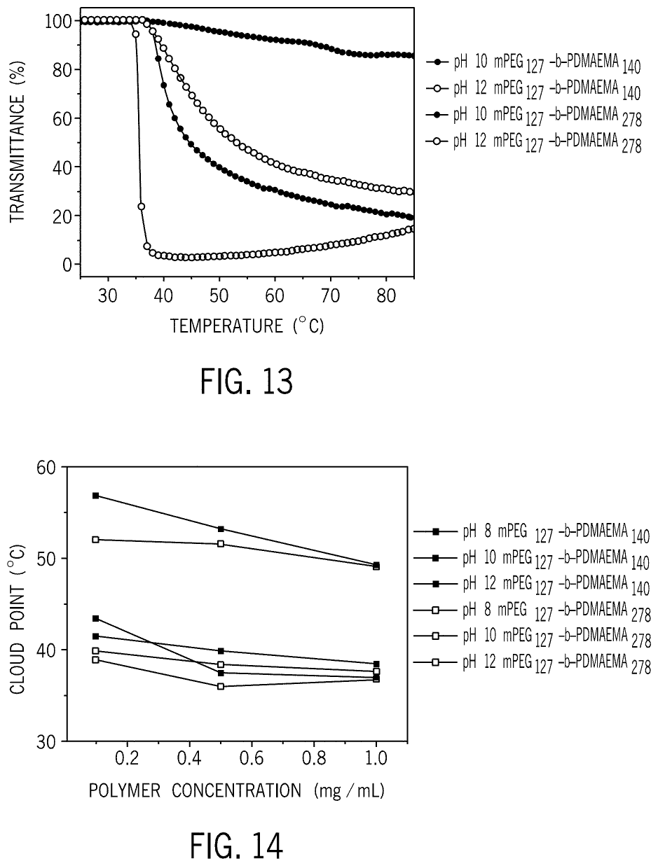

Further, in FIGS. 12 and 13, the transmittance of light in solutions containing diblock copolymers of varying MW shows a more rapid decrease in transmission with increasing temperature for lower MW diblock copolymers than for higher MW diblock copolymers at the same pH level.

In FIG. 14 the variability of the cloud point was evaluated with regard to changes in concentration of the diblock copolymer at different pH levels using UV-Vis. As shown, the cloud point decreases as polymer concentration increases due to the dependence of aggregation on particle concentration.

### Interfacial Tension

The block copolymers were additionally evaluated to determine the interfacial tension, which is the tendency of an interface of two liquids to become spherical to make its surface energy as low as possible. Interfacial tension/activity depends on the composition of the two phases, the block copolymer composition, the block copolymer concentration, as well as the pH and temperature of the overall composition. In performing these evaluations, a Ramé-hart Pendant Drop Tensiometer and software were used to find interfacial tension in mN/m, which is important to determine how evenly any particulates in the solution, i.e., the oxide coated TiO₂ particles, will be dispersed by the block copolymers in the solution/composition. As is shown in the following description and accompanying figures, interfacial tension in general increases as temperature increases for diblock and triblock copolymers. Further, polymer composition, pH, and polymer concentration have smaller effects on interfacial tension when compared to temperature.

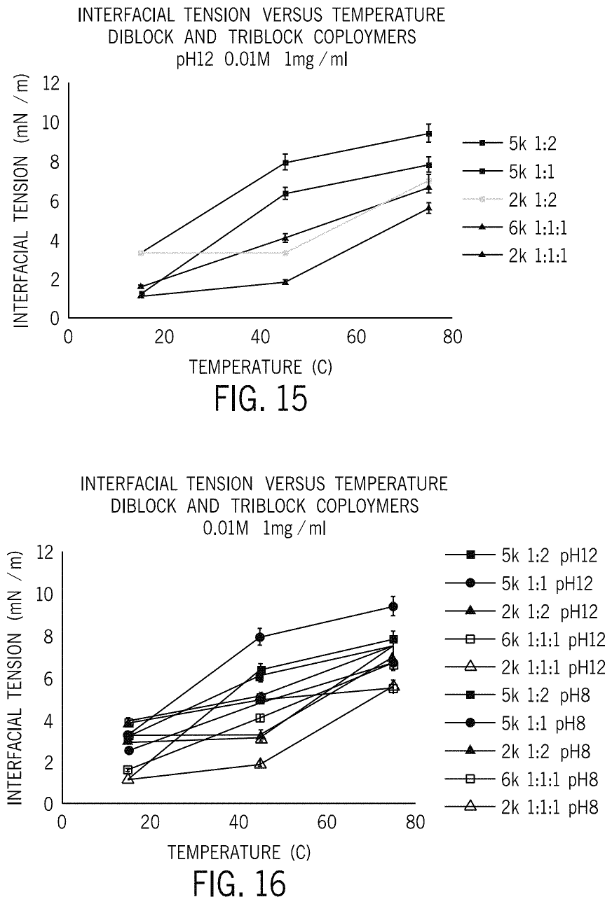

Initially, as shown in FIG. 15, the variation in interfacial tension (IFT) was determined for a number of diblock and triblock copolymers having different MW and different ratios of PDMAEMA to PEG. All measured interfacial tension values for the tested block copolymers fall within the range of 1 to 10 mN/m, as the pendant drop cannot reliably measure <1 mN/m. As shown, the block copolymer composition affects interfacial tension in multiple ways:
An increase in molecular weight increases interfacial tension.
An increase in ratio of PDMAEMA to PEG increases interfacial tension.
Diblock copolymers, in general, have higher IFT than similar molecular weight triblock copolymers.

FIG. 16 shows the results of a further investigation of the changes in IFT as a result of changes in temperature for different diblock and triblock copolymers at various pH levels. FIG. 16 shows that:
Copolymers have more stable IFT when in pH8 buffer than in pH12 buffer.
Low molecular weight polymers are more susceptible to large changes in IFT when the environment is changed.

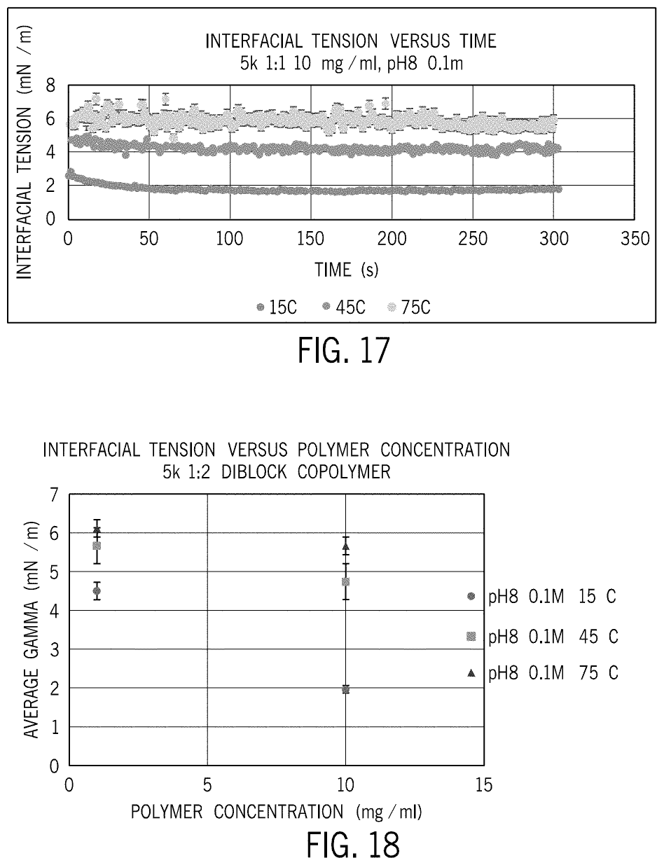

FIG. 17 illustrates the results of an evaluation of the changes in IFT versus time at a number of temperatures for a diblock copolymer. As shown:
Interfacial tension is time dependent until equilibrium is reached due to polymer interactions between liquidus phases.
Interfacial tension proportionally increases with temperature for polymers dispersed in aqueous solutions.

FIG. 18 shows the results of the comparison of IFT versus concentration for a diblock copolymer at a specified pH level, but with varying copolymer concentrations at different specified temperatures. As shown in FIG. 17, increasing block copolymer concentration decreases interfacial tension at all temperatures.

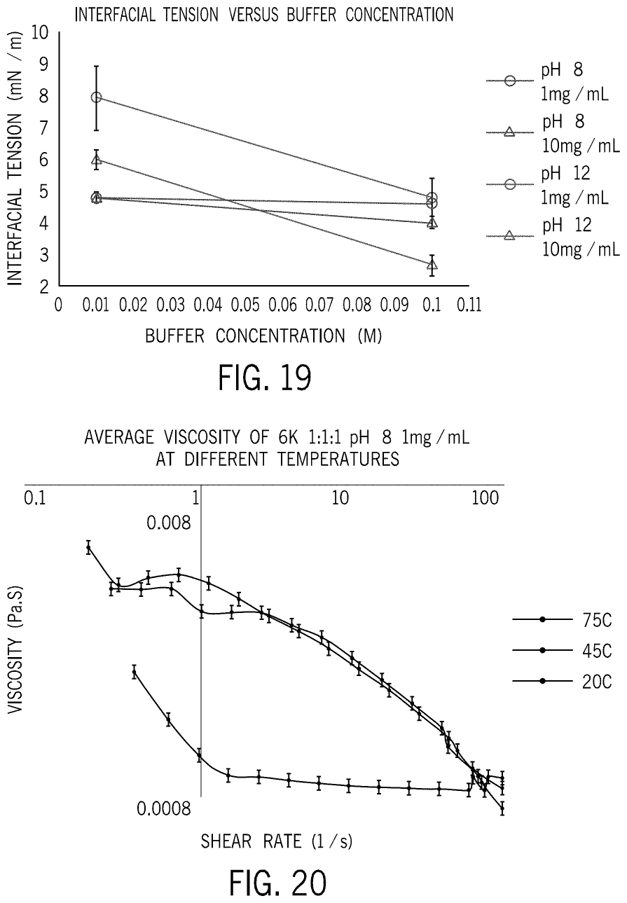

Finally, FIG. 19 illustrates the changes in IFT with regard to changes in the buffer concentration (pH level). As shown:
Copolymer more-readily interacts at interface when saturated.
Changing buffer concentration is more effective on IFT in basic solutions.
Solutions with higher copolymer content perform better as surfactants.

### Viscosity

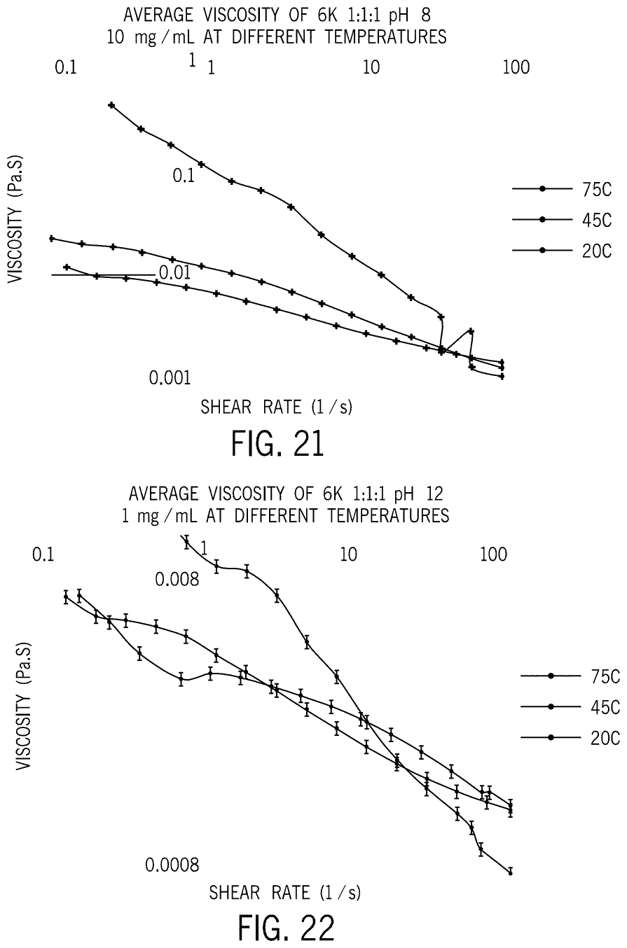

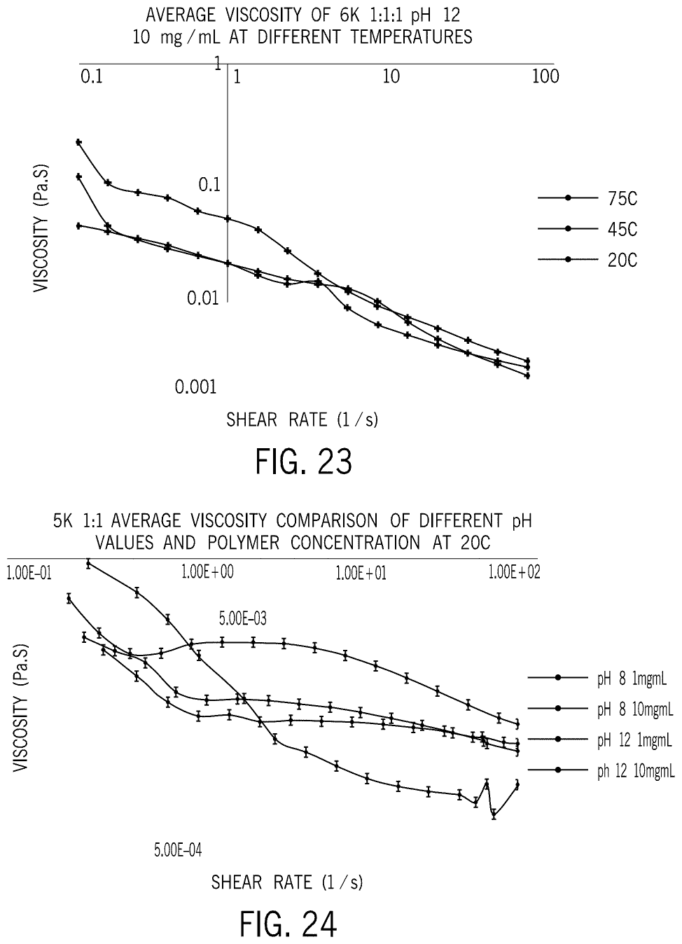

Viscosity is used to predict stability of dispersions and effect of temperature and pH on mixtures. Also, changes in the cloud point causes stimuli-responsive polymer aggregation, which results in a change in viscosity. In assessing the ability of the block copolymers to alter the viscosity of a composition as a result of changes in pH and/or temperature, a number of different tests were run utilizing a Discovery HR-2 Rheometer, which is used to measure a fluid's resistance to flow (viscosity). Viscosity characterization data shows how different samples of polymer react in different environments, in relation to each other. The viscosity characterization data illustrated in FIGS. 20-24 shows how different samples of polymer react in different environments, in relation to each other. In these figures, viscosity vs. shear rate as determined using the rheometer is shown at different temperatures and concentrations of a PDMAEMA₁₁₆-b-PEG₁₃₆-b-PDMAEMA₁₁₆ triblock copolymer, where shear rate is defined as the rate at which a layer of fluid passes over another layer.
There is a significant difference in the viscosity between 20 C and 75 C for pH 8 at a high shear rate for a triblock copolymer.
The PDMAEMA-PEG-PDMAEMA polymer decreases in viscosity as a higher shear rate is applied to it.
Temperature and pH affect the viscosity of PEG-PDMAEMA in water, which can change the properties of titanium dioxide dispersion in architectural coatings.
Viscosity data from PEG-PDMAEMA stimuli-responsive polymers showed a change in response to a change in temperature and pH.
   Properties of Block Copolymers with Titanium Dioxide Particles

In view of the test results discussed and shown previously, certain of the diblock and triblock copolymers were further evaluated in conjunction with TiO₂ particles to determine if the results provided by testing on the copolymers alone translated to compositions including the copolymers and the TiO₂ particles. In particular, the effects of these copolymers were evaluated with regard to the enhanced dispersion of additives in coating compositions, and more specifically with regard to the dispersion of titanium dioxide (TiO₂) particles, including TiO₂ particles coated with silica, aluminum or zinc oxides, in architectural coating compositions, such as paints and stains, among others.

Viscosity with TiO₂ Particles

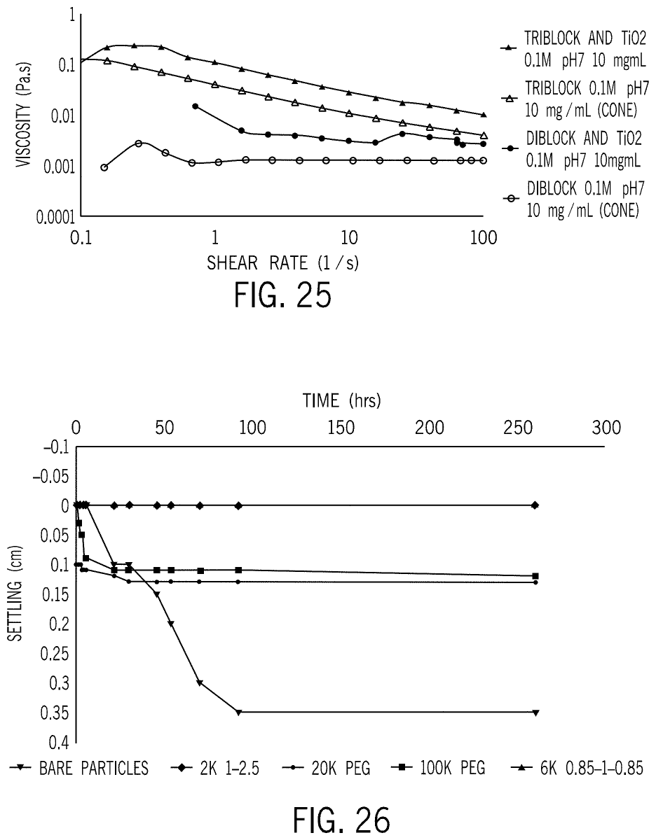

An analysis of the viscosity of diblock and triblock copolymers with and without TiO₂ particles was conducted on a DHR2 Rheometer with cone and plate (polymer solutions) or parallel plate (polymer with oxide-coated titanium dioxide). In the testing, pH, ionic strength, polymer and particle concentration, and equilibration time were each controlled to determine a measured viscosity as a function of shear rate, temperature, polymer concentration, and pH. As shown in FIG. 25, the results illustrate:
Shear thinning observed for all polymer samples, with more dramatic shear thinning for triblocks over diblocks.
Viscosity can be tailored using polymer composition.
Addition of particles increased the viscosity, as expected.

### Settling of TiO₂ in Copolymer Containing Solutions

The block copolymers were also tested to determine the effects on settling of dispersions of TiO₂ particles with and without the copolymers. For this evaluation, oxide-coated titanium dioxide samples obtained from Chemours and dispersed in pH 7 buffered water by sonication (both bath and horn), 20% by volume with 15% by volume polymer. The dispersion was stirred for three days, then image captured according to timescale shown, up to 260 hours or 10.8 days.

The results are shown in FIG. 26 and show that there was no settling, of the TiO₂ particles in the solutions including the diblock copolymers in comparison to solutions with only the TiO₂ particles and solutions including the TiO₂ particles and a control polymer having a viscosity comparable to that of the diblock copolymers, i.e., polyethylene glycol (PEG).

### TiO₂ Dispersions in Copolymer Containing Solutions

The copolymers having the desired attributes based on solubility, viscosity, and interfacial activity within the target pH and the target temperature range, were tested as polymer dispersants for silica-coated titanium dioxide. Samples of this material can be obtained from Chemours, a manufacturer of silica-coated titanium dioxide for architectural coating applications. The effectiveness of the PDMAEMA copolymers as polymer dispersants is measured using Dynamic Light Scattering, or DLS. This technique determines particle size in suspension. If the silica-coated titanium dioxide particles are ineffectively dispersed with a polymer dispersant, they will aggregate and result in a larger average particle size. If the polymer dispersant is effective, the average particle size will match the known individual particle diameter. The effectiveness of the PDMAEMA copolymer dispersant is determined as a function of temperature to determine the working temperature range of the material, pH to match the coating formulation, and polymer concentration to minimize cost. The dispersions have also been monitored as a function of time to determine shelf stability. The dispersions have also been tested with extremes in temperature, to determine if the dispersions are reversible for reuse and recycling capabilities. Viscosity of the dispersions have also been determined using the rheometer as a function of temperature, pH, and polymer concentration to determine if the viscosity falls within the target range for polymer dispersions.

The purpose is to determine how PDMAEMA copolymer composition and concentration affect the quality of the polymer dispersion for silica-coated titanium dioxide. Dispersions were tested as a function of both time and temperature to determine the working temperature range of the dispersions and the shelf stability of dispersions for potential architectural coating applications.

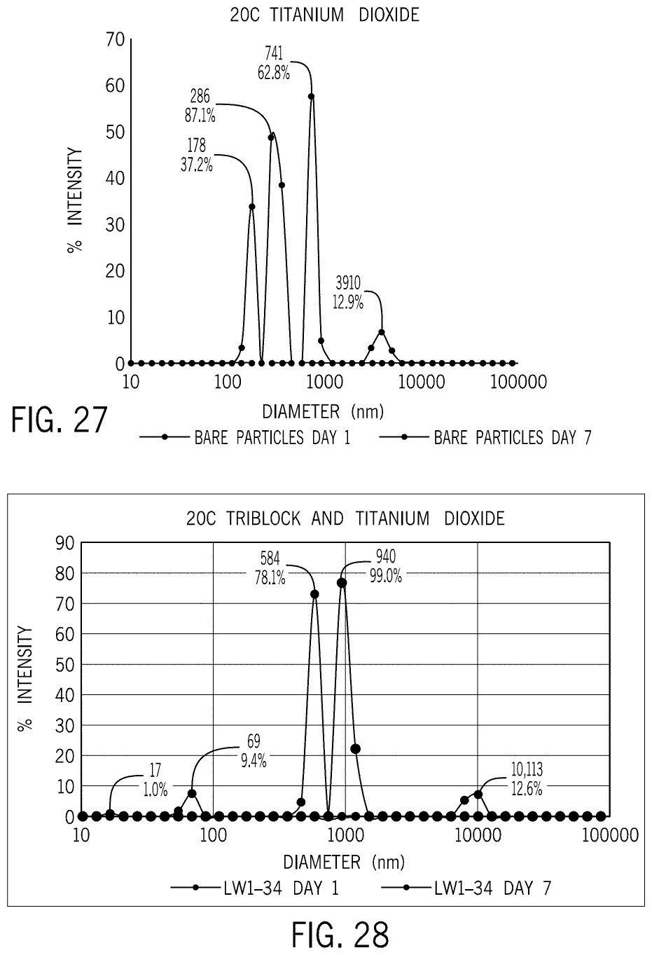

In a first evaluation, DLS time studies were performed on identical solutions of 20 volume % TiO₂ particles in pH 7 0.1M aqueous buffered solution, one of which included the addition of 165 mg/mL triblock copolymer PEG₁₂₇-b-PDMAEMA₁₄₀ that were maintained at a constant temperature of 20° C. and observed using DLS at 1 day and again at 7 days after dilution to 10⁻⁶ volume % immediately prior to characterization. The results are shown in FIGS. 27-28 and illustrates that the solution including the triblock copolymer maintained a significantly better and more uniform particle size of the TiO₂ particles (99%) even after 7 days, providing strong evidence of improved dispersion of the TiO₂ particles in solution.

In a second evaluation, DLS temperature studies were conducted on silicon oxide coated TiO₂ particle and TiO₂ particle-PEG₄₅-b-PDMAEMA₈₄ diblock copolymer suspensions prepared in pH buffer solution using sonication. DLS was used to analyze relative particle size to show if dispersion of aggregates occurs with the addition of diblock stimuli-responsive polymers. Dispersion is found to have occurred when the particle size decreases with the addition of the diblock copolymer.

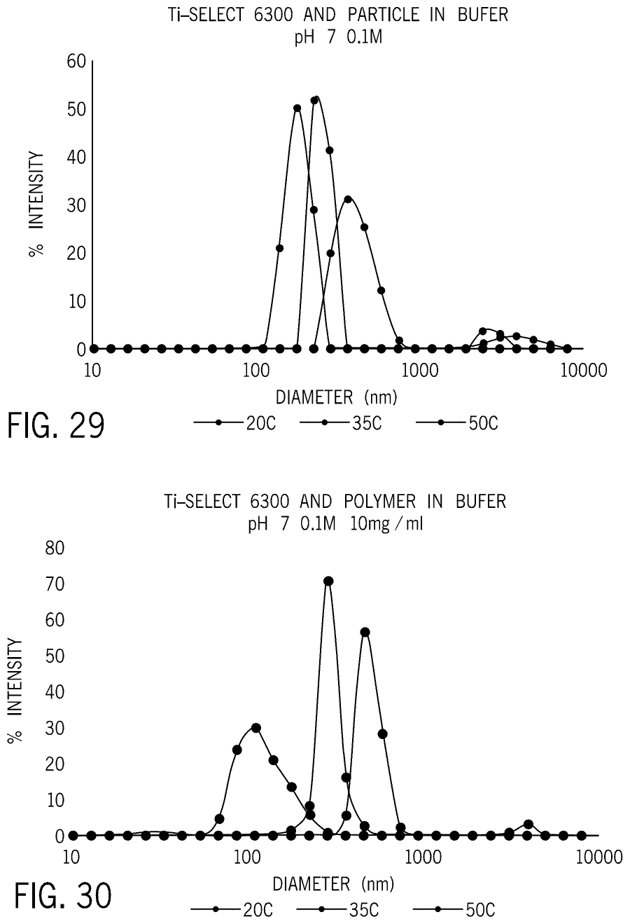

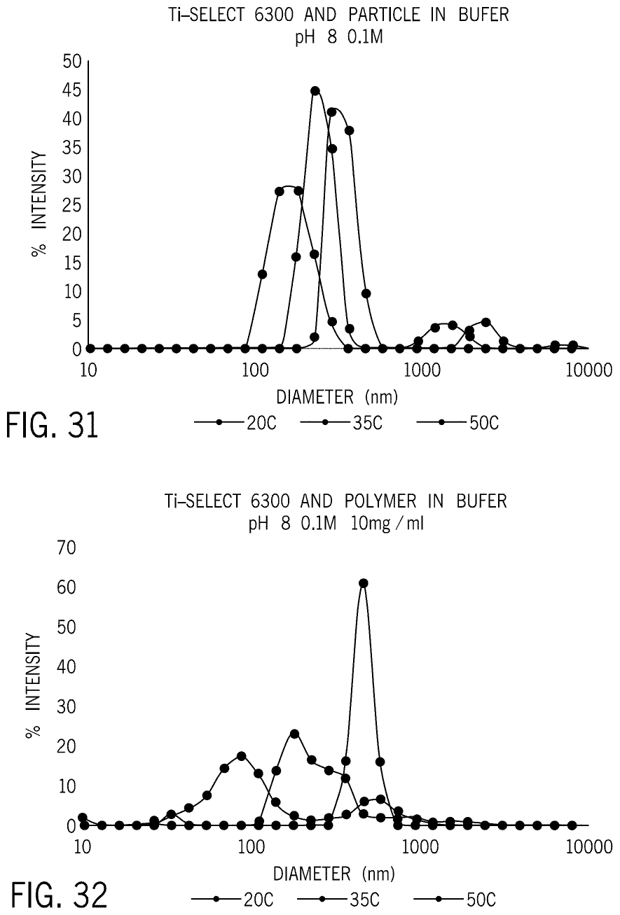

The results of the DLS testing are shown in FIGS. 29-32. In the solutions tested at pH levels of 7 and 8, in both cases the particle/copolymer solution provided greatly increased dispersion at higher temperatures 35° C. and at 50° C., with a slight improvement at 20° C., with the differences at pH 8 being much more significant than at pH 7. This, with increased pH and temperature, the copolymer greatly enhanced the dispersion of the TiO₂ particles in the solution.

### Architectural Coating Testing

With the prior results showing improved dispersion of the TiO₂ particles in solutions at higher pH levels (pH 8-pH 12) and higher temperatures above 25° C., certain diblock and triblock copolymers formed using the ARGET ATRP method as identified below in Table 3 have been utilized in architectural coating testing:

TABLE 3
Copolymers For Architectural Coating Testing

| | | Ratio | | | Demand |
|---|---|---|---|---|---|
| | Mw | PEG: | Sample | | Curve |
| Structure | PEG | PDMAEMA | Name | Synthesis Type | Testing? |
| Diblock | 2,000 | 1:1.15 | HK1-43 | ARGET ATRP | Yes |
| Diblock | 2,000 | 1:1 | PEGMOE | ARGET ATRP | Yes |
| (MOE) | | | | | |
| Diblock | 2,000 | 1:2 | | ARGET ATRP | |
| Diblock | 2,000 | 1:4 | KB1-30 | ARGET ATRP | Yes |
| Diblock | 5,000 | 1:0.5 | | ARGET ATRP | |
| Diblock | 5,000 | 1:1 | | ARGET ATRP | |
| Diblock | 5,000 | 1:2 | | ARGET ATRP | |
| Triblock | 2,000 | 1:1:1 | | ARGET ATRP | |
| Triblock | 2,000 | 2:1:2 | SS1-42 | ARGET ATRP | Yes |
| Triblock | 6,000 | 0.85:1:0.85 | LW1-44 | ARGET ATRP | Yes |

Commercially available coated titanium dioxide particles used in testing (including tests previously described) are as follows in Table 4:

TABLE 4
TiO₂ Particles For Architectural Coating Testing

| Name | Size (nm) | Density (g/cm3) | Surface Coating |
|---|---|---|---|
| Chemours Ti-Select 6300 | 380 | 3.7 | Al, Si |
| KRONOS 2310 | 274 | 4.0 | Al, Si, Zr |

The particle sizing for these particles has been done using field emission scanning electron microscopy on gold coated drop cast samples. We have additional particle samples yet, but have focused our testing on these two samples to date. All available samples have different combinations of surface coatings (Al, or Al/Si, or Al/Si/Zr).

### Rheology Testing

A. Demand Curves:

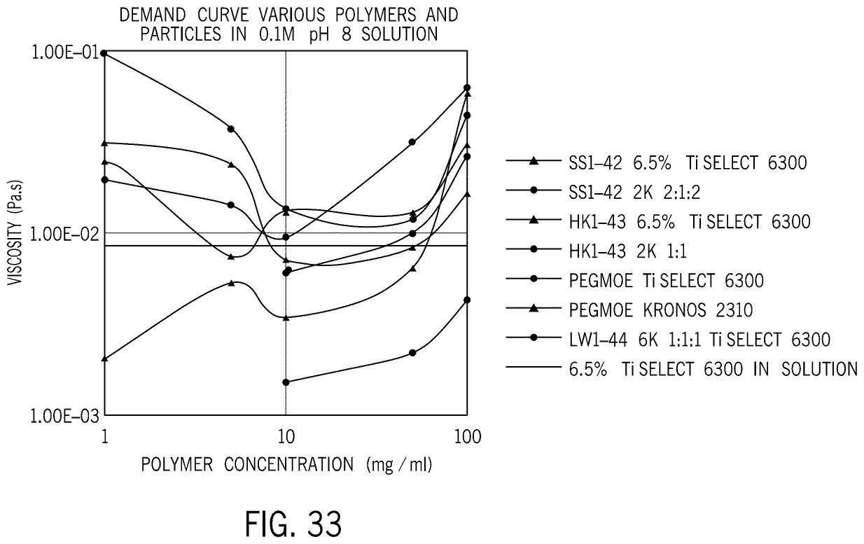

As shown in FIG. 33, demand curves were produced to optimize the amount of polymer being added to paint formulations. Particle-polymer samples are made with set particle concentration (6.5 volume %) and varied polymer concentration (1-100 mg/ml) in 0.1 M pH 8 aqueous buffered solution. The steady shear viscosity is then analyzed using a Discovery HR2 Rheometer. These data are plotted in excel and the ideal polymer concentration can be found when the viscosity reaches a minimum. Demand curve data was compared to the steady shear viscosity for the pure polymer or pure titanium dioxide sample in aqueous buffered solution, where available. Diblock and triblock copolymers were tested with different surface coated titanium dioxide samples.

B. Formulations

Finished paint formulations were purchased and analyzed using steady state flow procedures (Pittsburgh and Forever paint samples). These were compared to diblock and triblock polymer samples with Ti Select 6300 particles in pH 8 buffered solution, with 6.5 volume % TiO2 set to be 100%. Decreased amounts of TiO2 were tested relative to the 100% TiO2 amount. Initial formulations were prepared following the components and ratios described in Reference 9, cited and incorporated by reference below. Substitutions were made when the original components were not available. (We used Tafigel Pur 61 instead of Acrysol RM-1020, Foamaster MO 2192 instead of Foamaster VL, Rheobyk-H 6400 VF instead of Acrysol SCT-275, and RayKote 2000 instead of RHA 184). Viscosity data was obtained with varying concentrations of the components to achieve desired viscosity behavior. Viscosity modifiers were tested individually (no dilution), and then in combination. The PEG-PDMAEMA:particle ratio was fixed using the demand curve data.

### Sample Preparation

The samples were prepared in two steps, a mill-base step and a let-down step as shown in Table 5. Ingredients from each step were mixed separately in two different 20 mL vials. A small stirring bar was added to each vial to help the materials to mix while adding each ingredient. Regarding the mill-base step, once all the materials are added, the vial was taken to a sonic bath and left to sonicate for an hour. Then, it was taken to an ultrasonic homogenizer sonicator for 60 seconds to ensure that TiO₂ particles are completely mixed and disappeared with the liquid ingredients. Once done mixing the ingredients from the mill-base step, the ingredients from the let-down step were added to the mill-base vial and mixed again using an ultrasonic homogenizer sonicator.

TABLE 5
Water-Based Paint Formulation Used in the Experiment
(100% Raykote 2000 and 100% TiO₂)

| | |
|---|---|
| | Standard Content of each |
| Materials | Material |

Mill base Step:

| | |
|---|---|
| 1) Propylene Glycol | 0.435 mL |
| 2) Water | 0.450 mL |
| 3) Ammonia | 0.018 mL |
| 4) Polymeric dispersant | 0.079 g |
| 2k 2-1-2 (Triblock copolymer) | |
| 5) Foamaster MO 2192 | 0.033 mL |
| 6) TAFIGEL ® PUR 61 | 0.114 mL |
| 7) Lower the speed while | 2.051 g |
| adding Ti-select-6300 | |

Letdown step:

| | |
|---|---|
| 1) Water | 0.180 mL |
| 2) Raykote 2000 | 6.30 mL |
| 3) Texanol | 0.162 mL |
| 4) Propylene glycol | 0.030 mL |
| 5) Foamaster MO 2192 | 0.0075 mL |
| 6) RHEOBYK-H 6500 VF | 0.006 mL |
| 7) Premix Natrosol in water | 6.150 mL |
| (4 wt %) | |

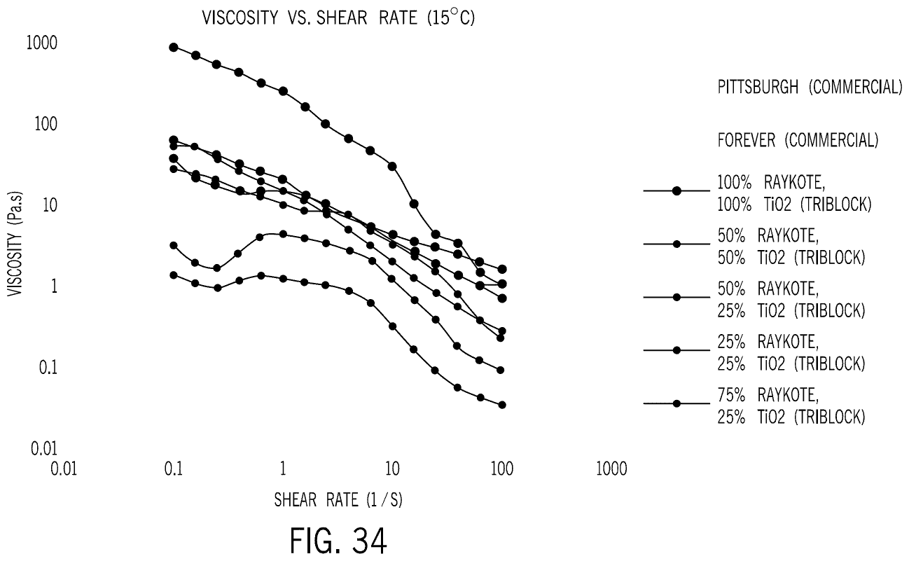

The different combination/ratios of rheology modifier with triblock copolymer/Ti Select TiO2 particles were then evaluated to determine the viscosity of the samples versus shear rate in order to attempt to match viscosity profile of commercially available paint samples, which were also tested. The results of the testing are shown in FIG. 34, where the combinations of 50% and 75% Raykote each with 25% TiO2 particles and the triblock copolymer appear to best approximate the viscosity profiles of the commercial paint products tested. In addition, the viscosity profile could be maintained while decreasing the amount of viscosity modifier (Raykote) and TiO2/polymer dispersant (light blue and golden-brown data). Additional testing is needed to determine if additional properties are maintained, like coverage/opacity.

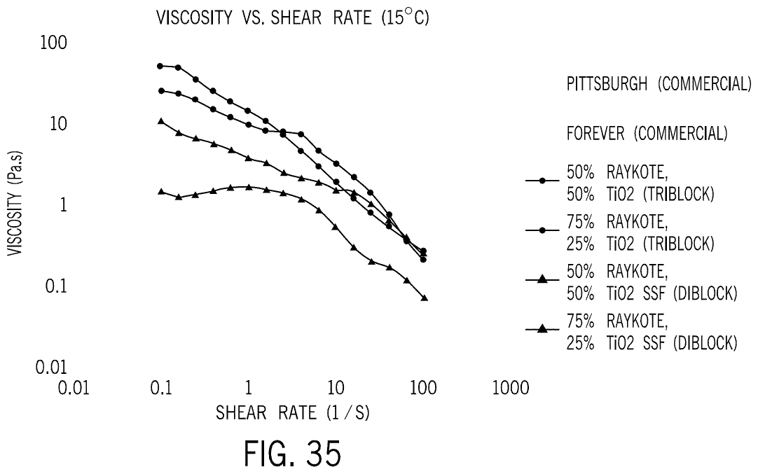

Further, in FIG. 35 the same testing procedure for viscosity versus shear rate was performed as for the results of FIG. 34 for the commercial products in comparison with diblock and triblock copolymers as polymer dispersants with different concentrations of rheology modifier and TiO2 particles. As shown in the results of FIG. 35 the diblock vs. triblock formulations result in different slopes in viscosity profile as a function of shear rate. Both can achieve decrease in viscosity modifier (Raykote) and TiO2 concentration while maintaining zero shear viscosity and shear thinning behavior comparable to commercially available formulations. Again, further testing is needed to test other properties such as coverage/opacity.

### REFERENCES

The following references are expressly incorporated by reference herein in their entirety for all purposes.
1. Stubbs, E.; Laskowski, E.; Conor, P.; Heinze, D. A.; Karis, D.; Glogowski, E. M., Control of pH- and temperature-responsive behavior of mPEG-b-PDMAEMA copolymers through polymer composition. Journal of Macromolecular Science Part a-Pure and Applied Chemistry 2017, 54 (4). 228-235.
2. Peng, Z. P.; Li, G. Z.; Liu, X. X.; Tong, Z., Synthesis, pH- and temperature-induced micellization and gelation of doubly hydrophilic triblock copolymer of poly(N,N-dimethylamino-2-ethylmethacrylate)-b-poly(ethylene glycol)-b-poly(N,N-dimethylamino-2-ethylmethacrylate) in aqueous solutions. Journal of Polymer Science Part a-Polymer Chemistry 2008, 46 (17), 5869-5878.
3. Min, K.; Ciao, H. F.; Matyjaszewski, K., Use of ascorbic acid as reducing agent for synthesis of well-defined polymers by ARGET ATRP. Macromolecules 2007, 40 (6), 1789-1791.
4. Simakova, A.; Averick, S. E.; Konkolewicz, D.; Matyjaszewski, K. “Aqueous ARGET ATRP” Macromolecules, 2012, 45, 6371-6379.
5. Dong, H; Matyjaszewski, K.; “ARGET ATRP of 2-(Dimethylamino)ethyl Methacrylate as an Intrinsic Reducing Agent” Macromolecules 2008 41, 6868-6870.
8. Creutz, S.; Jerome, R.; “Effectiveness of block copolymers as stabilizers for aqueous titanium dioxide dispersions of a high solid content” Progress in Organic Coatings, 2000, 40, 21-29.
9. Farrokhpay, S.; Morris, G. E.; Fomasiero, D.; “Titania Pigment Particles Dispersion in Water-Based Paint Films”JCT Research, 2006, 3, 275-283.

Various other embodiments of the invention are contemplated as being within the scope of the filed claims particularly pointing out and distinctly claiming the subject matter regarded as the invention.

1. A composition for use as a dispersing agent for titanium dioxide particles comprising a block copolymer formed from polyethylene glycol (PEG) and poly(2-dimethylaminoethyl methacrylate) (PDMAEMA).

2. The composition of claim 1 wherein the copolymer is a diblock copolymer.

3. The composition of claim 2 wherein the diblock copolymer has a molar ratio of PEG:PDMAEMA of between about 1:0.5 to about 1:4.5.

4. The composition of claim 1 wherein the copolymer is a triblock copolymer.

5. The composition of claim 4 wherein the triblock copolymer has a molar ratio of PDMAEMA:PEG:PDMAEMA of between about 0.85:1:0.85 to 3:1:3.

6. The composition of claim 1 wherein the copolymer has a molecular weight of PEG of between about 2000 and about 6000.

7. The composition of claim 1 wherein the copolymer has a molecular weight of PDMAEMA of between about 7000 and about 45,000.

8. The composition of claim 1 wherein the block copolymer has the following formula: 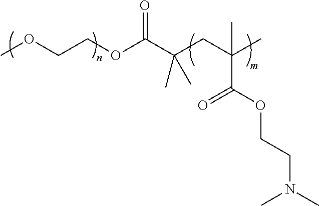
wherein n is between 44 and 127, and
wherein m is between 44 and 278.

9. The composition of claim 1 wherein the block copolymer has the following formula: 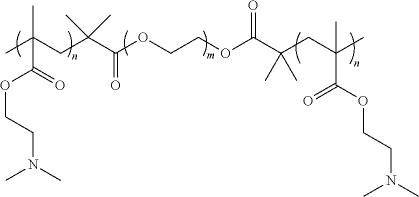
wherein n is between 45 and 136, and
wherein m is between 49 and 135.

10. The composition of claim 1 wherein the block copolymer is formed using Atom Transfer Radical Polymerization (ATRP).

11. The composition of claim 1 wherein the block copolymer is formed using Activator Regenerated by Electron Transfer Atom Transfer Radical Polymerization.

12. A composition of matter comprising:
an effective amount of a block copolymer formed from the group consisting of a diblock copolymer and a triblock copolymer formed of triblock polyethylene glycol (PEG) and poly(2-dimethylaminoethyl methacrylate) (PDMAEMA); and
an amount of surface-coated titanium dioxide particles.

13. The composition of matter of claim 12 further comprising a carrier.

14. The composition of matter of claim 13 wherein the composition of matter is a water-based paint composition.

15. The composition of matter of claim 13 wherein the composition of matter is an oil-based paint composition.

16. The composition of matter of claim 13 wherein the composition of matter is a dispersion of the surface-coated titanium dioxide particles in the carrier.

17. The composition of matter of claim 16 wherein a temperature of the composition of matter is between 15° C. and 75° C.

18. The composition of matter of claim 16 wherein a pH value of the composition of matter is above 7.

19. The composition of matter of claim 18 wherein the pH value of the composition is between 8 and 12.

20. The composition of matter of claim 12 wherein the effective amount of the block copolymer is between about 0.1 mg/mL and about 10 mg/mL.
